(19) United States
(12) Patent Application Publication
(10) Pub. No.: US 2008/0176587 A1
(43) Pub. Date: Jul. 24, 2008

(54) System and a method for sending digital content to a mobile device

(76) Inventors: Yossi Glazer, Rechovot (IL); Shlomi Levi, Zoran (IL)

Correspondence Address: Martin D. Moynihan;PRTSI, Inc., P.O. Box 16446, Arlington, VA, 22215, US

(21) Appl. No.: 11/655,953

(22) Filed: Jan. 22, 2007

(51) Int. Cl. H04M 11/00; H04Q 7/20

(52) U.S. Cl. 455/466; 455/406

(57) ABSTRACT

A method for sending digital content to a mobile device comprises: 1) providing a client application capable of designating an address of the mobile device and digital content appearing in a display of a hosting computing unit, 2) acquiring the address and the digital content via a computer network connected to the hosting computing unit, 3) embedding the digital content in a cellular message directed to the address, and 4) forwarding the cellular message to the mobile device via a hosting cellular network.

### FIELD AND BACKGROUND OF THE INVENTION

The present invention relates to a system, an apparatus, and a method for sending digital content to a mobile device, such as a mobile phone and, more particularly, but not exclusively to a system, an apparatus, and a method for sending digital content to a mobile device using a network accessible server.

One of the most popular communication technologies that have been developed for mobile communications systems is text messaging, in particular the short message service (SMS) that allows mobile users to receive text messages via wireless communication devices, including SMS-capable cellular mobile phones. Mobile and stationary users can send messages to recipient users by entering a text message and the destination address of the recipient user, who can be either a mobile or a non-mobile user.

Based on the ability to send cellular messages, a number of electronic information services have been developed around SMS technology. For instance, electronic information services have integrated SMS into their systems in a manner that allows them to provide a number of services including email-to-SMS and fax-to-SMS, paging-to-SMS, interactive banking, and general information services such as providing financial information. Thus, cellular messaging is not limited to transmitting textual messages between users, but has developed into a general system for wireless communication of electronic information. As a result, an SMS message may include not only text messages entered by mobile and non-mobile users, but may also include e-mail, fax, paging, financial, news, and other electronic information.

Moreover, during the last years, a multimedia messaging service (MMS) standard, which is a standard for a telephony messaging systems that allow sending messages that includes multimedia objects, such as images, audio, video, rich text etc., became very common.

It is presently known that personal computers or other Internet-accessible devices can send text messages to SMS-capable mobile devices and media objects to MMS-capable mobile devices, via a web browser. As an example, Verizon Wireless™ and many other cellular communications operators allow Internet users to access their website and type a message intended for one of its subscribers. The Internet user then enters a target address, such as a telephone number or a predefined user name, to identify the recipient subscriber. Upon submission, the message is sent to the cellular network via an SMS gateway.

An example for a system that allows such a communication is described in U.S. Pat. No. 7,149,537, published on Dec. 12, 2006. The Patent discloses a system and method for providing a user-accessible Internet-based mobile messaging log that records messages communicated between an Internet-based sending device and an SMS-capable mobile device. An SMS messaging log is created for each Internet-based user that sends messages to SMS-capable mobile devices. The mobile user is then able to access their SMS messaging log via the Internet and view the SMS messages sent to the SMS-capable device. The message log also records and displays replies sent by the SMS-based user in response to the sent message. The system and method utilize a unique tracking identification number to match original messages to replies in the mobile messaging log.

Another example for such a communication is described in U.S. Pat. No. 7,113,801 issued on Sep. 26, 2006. The patent describes a method and system for receiving data by using the SMS and wireless Internet. The method comprises the steps of receiving a short message from a service provider, wherein the short message comprises at least a service identifier and site information, determining whether there is an application protocol in the site information and executing an IP-channel connecting program in correspondence with the application protocol. The application protocol is in the site information, wherein the data receiving system receives data in correspondence with the application protocol from the service provider by executing the IP-channel connecting program.

However, although currently available systems provide a number of solutions for communication between stationary computers and mobile devices; new communication and data transfer solutions can still be explored. There is thus a widely recognized need for, and it would be highly advantageous to have, a system and a method that provide new communication and data transfer solutions.

### SUMMARY OF THE INVENTION

According to one aspect of the present invention there is provided a method for sending digital content to a target mobile device. The method comprises the following steps: a) providing a client application for designating an address of the target mobile device and for designating digital content appearing in a display of a hosting computing unit; b) acquiring the address and the digital content via a computer network connected to the hosting computing unit; c) embedding the digital content in a cellular message directed to the address; and d) forwarding the cellular message to the mobile device via a hosting cellular network.

Preferably, the digital content comprises a member of the following group: a textual data, a paragraph, a section of a paragraph, a sentence, a word, a combination of characters, a graphical data, an image, a video track, an audio track, and a file.

Preferably, the cellular message comprises a member of the following group: a short message service (SMS) and a multimedia messaging service (MMS).

Preferably, the forwarding is performed using a member of the following group: a short message service (SMS) gateway and a multimedia messaging service (MMS) gateway.

Preferably, the designating comprises receiving a designation made by a user.

Preferably, the designating comprises designating with a pointing device.

Preferably, the digital content comprises textual data, the designating comprises causing execution of a text recognition algorithm to identify the textual data.

Preferably, the digital content comprises textual data, the designating comprises causing execution of optical character recognition to identify the textual data.

Preferably, the forwarding comprises forwarding the cellular message to the cellular network via at least one of the following members: an short message service (SMS) dealer, a multimedia messaging service (MMS) dealer, an SMS center (SMSC), and an MMS center (MMSC).

Preferably, the designating is performed by a user, further comprising a step of billing the user for the forwarding.

Preferably, the acquiring further comprises acquiring an identifier to the digital content from the client application, wherein the digital content is acquired according to the identifier.

Preferably, the identifier is a member of the following group: a link, a pointer, a physical address, and a logical address.

More preferably, the forwarding is performed according to a default address if no other address is acquired during step b).

Preferably, the method further comprises a step between step b) and c) of identifying the type of the digital content and extracting predefined information from the digital content according to the identification.

More preferably, the type comprises a member of the following group: an email, a schedule, and a note.

More preferably, the predefined information comprises a member of the following group: a date, a time, a location, and attendees of a meeting.

Preferably, the method further comprises a step before step b) of acquiring a sending address, wherein the cellular message is defined according to the sending address during the step c).

Preferably, the client application capable of designating a number of addresses of a number of respective target mobile devices, the acquiring comprises acquiring the number of addresses, the embedding comprises the digital content in a number cellular messages, each directed to a respective address of the number of addresses, the forwarding comprises forwarding the number cellular messages to the respective mobile devices.

Preferably, the method further comprises a step of storing the cellular message.

Preferably, the stored message is used as marketing information.

More preferably, the marketing information is used for a member of the following group: personalized advertising, focused marketing, and behavioral based marketing.

According to one aspect of the present invention there is provided a system for sending digital content to a mobile device having a target address. The system comprises a client application for designating a target address of the mobile device and digital content appearing in a display of a hosting computing unit and a network accessible server, operatively connected to the client application via a computer network The network accessible server is usable for embedding the designated digital content into a cellular message directed to the target address, the network accessible server is adapted for forwarding the cellular message to a cellular network hosting the mobile device, thereby providing the cellular message to the mobile device.

Preferably, the digital content comprises a member of the following group: a textual data, a paragraph, a section of a paragraph, a sentence, a word, a combination of characters, a graphical data, an image, a video track, an audio track, and a file.

Preferably, the cellular message comprises a member of the following group: a short message service (SMS) and a multimedia messaging service (MMS).

Preferably, the designating comprises receiving a designation made by a user of the hosting computing unit.

Preferably, designating comprises designating with a pointing device.

Preferably, the digital content comprises textual data, wherein the client application comprises a text-grabbing module for identifying the textual data in the digital content, the textual data being embedded into the designated digital content.

More preferably, the identification is performed using a member of the following group: a text recognition algorithm and an optical character recognition algorithm.

More preferably, the system further comprising a billing server, operatively connected to the network accessible server, the network accessible server being configured for storing billing information about the user.

More preferably, the billing server is used for storing the cellular message.

More preferably, the cellular message is used for a member of the following group: personalized advertising, focused marketing, and behavioral based marketing.

More preferably, the forwarding comprises forwarding the cellular message to the cellular network via at least one of the following members: an short message service (SMS) dealer, a multimedia messaging service (MMS) dealer, an SMS center (SMSC), and an MMS center (MMSC).

More preferably, the network accessible server authenticates the user before the forwarding.

According to one aspect of the present invention there is provided a network accessible server adapted for forward digital content to a mobile device. The server comprises an input interface for receiving the digital content and the address of the mobile device from a client application, via the computer network, the digital content comprises information appearing in a display of a computing unit hosting the client application. The server further comprises a transformation unit for transforming the digital content to a cellular message directed to the address and a cellular network interface adapted to be connected to a cellular network hosting the mobile device, thereby allowing the transmission of the cellular message to the mobile device.

According to one aspect of the present invention there is provided a system for billing to a mobile device owner for a purchase. The system comprises a client application capable of designating an identifier of the purchase appearing in a display of a hosting computing unit and a network accessible server, operatively connected to the client application via a computer network, being usable for identifying the price of the purchase, the network accessible server is adapted forwarding at least one cellular message to a cellular network hosting the mobile device, thereby billing the account of the mobile device owner for the purchase.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method, the apparatus, and the system of the present invention involves performing or completing certain selected tasks or steps manually, automatically, or a combination thereof. Moreover, according to actual instrumentation and equipment of preferred embodiments of the method, the apparatus, and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method, the apparatus, and the system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a system for sending digital content to a mobile device, according to a preferred embodiment of the present invention;

FIG. 2 is a schematic illustration of a network accessible managing server, according to a preferred embodiment of the present invention;

FIG. 3 is a schematic illustration of a system for sending digital content from a hosting computing unit to a mobile device, according to a preferred embodiment of the present invention;

FIGS. 4A and 4B are respectively an exemplary illustration of a screen display and a screen display with a graphical user interface (GUI) for sending digital content, according to an embodiment of the present invention; and

FIG. 5 is a flowchart of an exemplary method for sending digital content that appears on a display of a computing unit to a mobile device, according to a preferred embodiment of the present invention.

### DESCRIPTION OF THE PREFERRED EMBODIMENTS

The present embodiments comprise an apparatus, a system, and a method for sending digital content appearing in a display of hosting computer device to a mobile device via a computer network, such as the Internet.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A computer network may be understood as an IP-based network, the Internet, a local Ethernet, a Virtual Private Network (VPN), a WLAN, a LAN, a wireless network, or the combination thereof.

A computing unit preferably comprises a processor, and may additional include peripherals such as a display, a keyboard, and a pointing device as necessary. The pointing device typically comprises a mouse, but may comprise a track-ball, joystick, digitizing pad, touch screen, or keyboard. The computing unit may comprise substantially any electronic device capable of presenting text for a user to view. As appropriate, a computing unit may comprise, for example, a desktop computer, a laptop or notebook computer, a personal digital assistant (PDA) which communicates via a wireless network, or a television.

Digital content may be understood as textual data such as a paragraph or a section thereof, a link, a pointer, a physical address, a logical address, a sentence, a file, a word, or any combination of characters, a graphical data such as an image, a video track, an audio track, or any combination thereof.

A cellular message may be understood as an SMS, a MMS, or any other communication for cellular messaging.

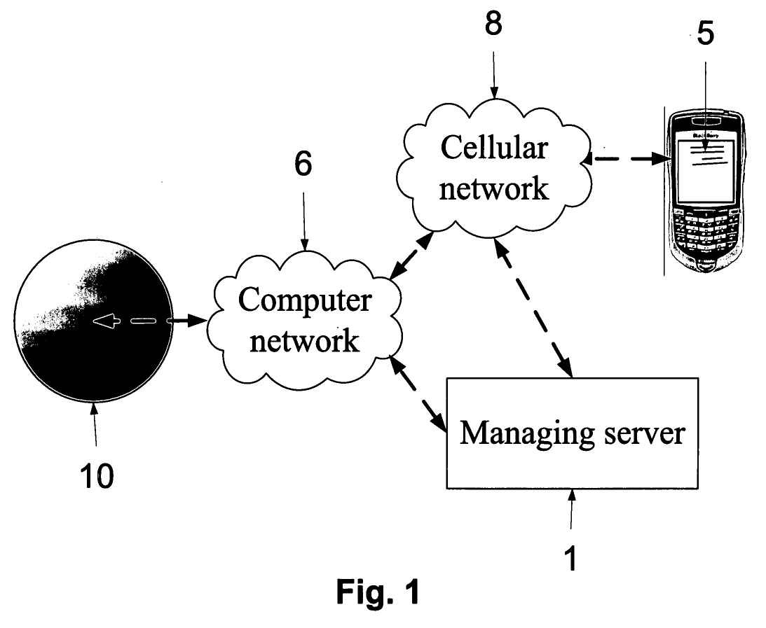

Reference is now made to FIG. 1, which is a schematic illustration of a system 100 for sending digital content to a mobile device 5. Such a system comprises a client application 10 that allows a user to designate a target address of the mobile device 5 and allows digital content appearing in a display of a hosting computing unit to be defined. The system 10 further comprises a network accessible managing server 1, which is connected to the client application via a computer network 6. The server embeds the defined digital content into a cellular message that is then directed to the designated target address. The server forwards the cellular message, either directly or via the computer network 6, to a cellular network 8 that hosts the mobile device 5. The cellular network 8 delivers the cellular message to the mobile device. Such a system 10 allows a user to designate any graphical or textual information that appears in the display of the hosting computing unit and to send it as an SMS or multimedia messaging service (MMS) to a chosen mobile device. The user designates digital content such as a schedule, a remainder, a map, an image, a file, etc. and sends the digital content to his mobile device or to a mobile device of an acquaintance. Such a cellular message can be used instead of a respective written note. Sending such cellular messages saves time and prevents potential lost of a respective written note. The system can send the cellular message to mobile devices having diverse hardware and therefore no designated installation is needed for enabling the system.

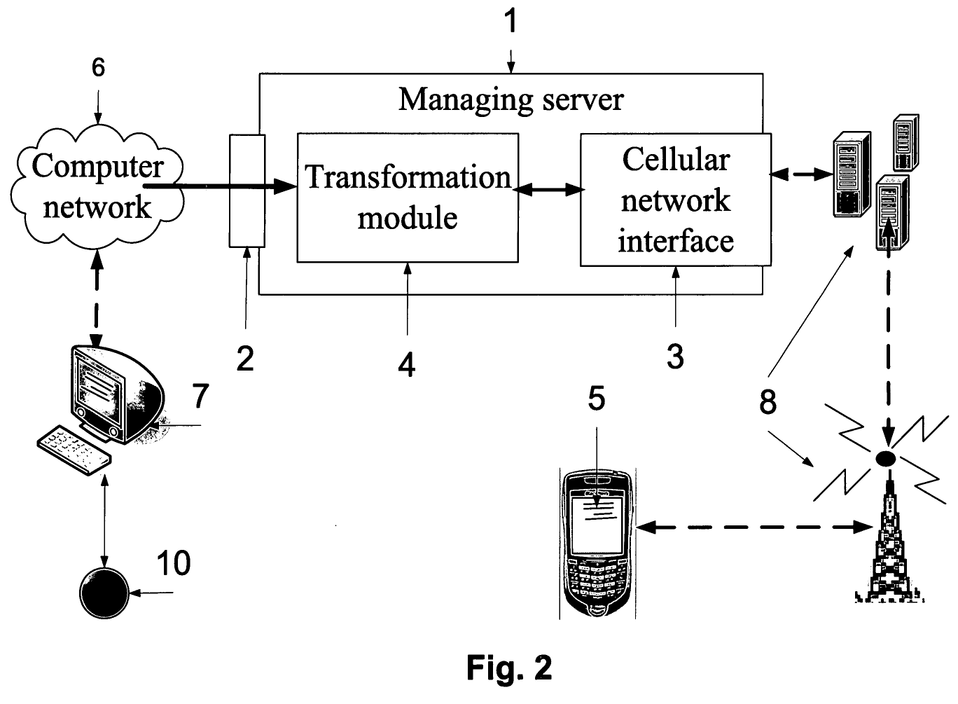

Reference is now made to FIG. 2, which is a schematic illustration of the network accessible managing server 1, which is depicted in FIG. 1, according to a preferred embodiment of the present invention. The computer network 6, the cellular network 8, and the client application as in FIG. 1, however in FIG. 2 the managing server 1 is described more completely. As depicted, the managing server 1 comprises an input interface 2, a cellular network interface 3, and a transformation module 4, such as an MMS/SMS gateway. The input interface 2 is used for receiving, via a computer network 6, digital content and an identifier, such as a target address, of a mobile device 5, from a client application 10 that is hosted on a computing unit 7. The digital content comprises information appearing in the display of the computing unit 7. In use, the digital content and the identifier are designated by a user using the client application 10. The client application 10 may be running on Windows™ or on Macintosh operating system (MAC OS™) operating systems. Preferably, the user downloads the client application 10 from the managing server 1 or from any other assigned server and installs it on the computing unit 7. A more detailed description of the designating process is given below.

The transformation module 4 transforms the digital content to a cellular message that is addressed to the mobile device 5, according to the designated identifier. For example, if the digital content is textual information, it is converted into a specific data format or protocol, which is required for the communication with a SMS Center (SMSC) of a specific provider, as further, described below. Subsequently, the converted digital content is transmitted by means of one of the conventional protocols SMPP, UCP or CIMD to the SMSC. According to another example, if the digital content is a multimedia object, such as AVI, WAV, MPEG, and MP3, it is converted into a specific data format or protocol, such as the 3GPP (.3gp) file format, AMR/AWB (.amr/.awb) storage format, H.263 format, or wideband and narrow-band-AMR-supported formats according to the requirements of a related MMS Center (MMSC) of a specific provider.

The cellular network interface 3 allows the forwarding of the cellular message to the designated mobile device 5 via a cellular network 8.

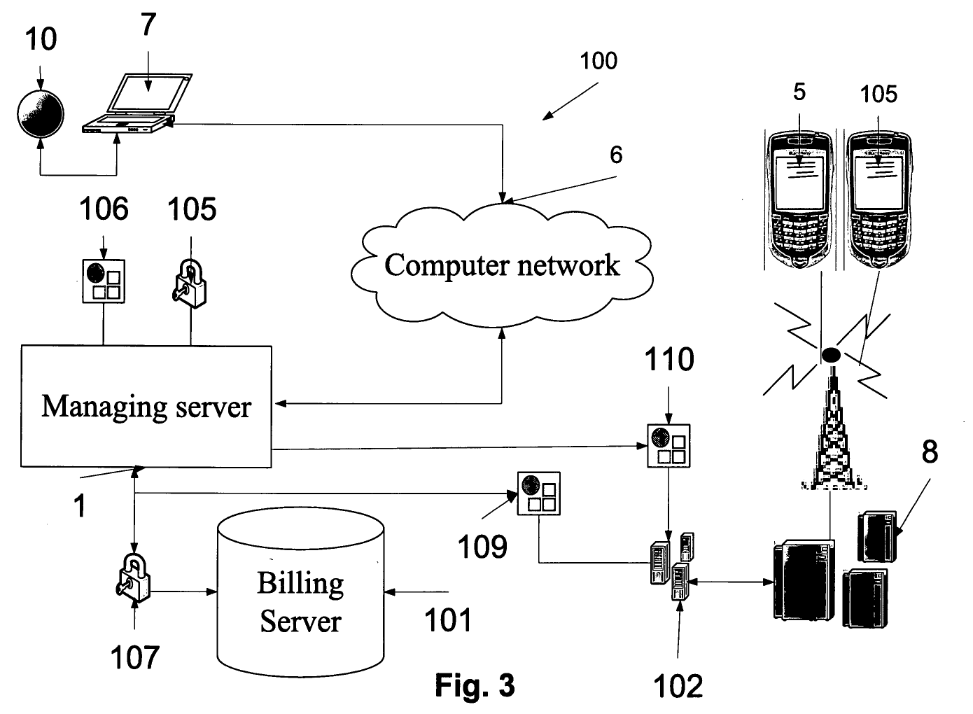

Reference is now made to FIG. 3, which is a schematic illustration of a system 100 for sending digital content from a hosting computing unit 7 to a mobile device 5, according to a preferred embodiment of the present invention. The managing server 1, the hosting computing unit 7, the mobile device 5, the computer network 6, and the cellular network 8 are substantially as in FIG. 2, however in the embodiment, which is depicted in FIG. 3, a billing server 101 and a cellular messages dealer 102 are connected to the managing server 1. It should be noted that although only one computational unit 7 is depicted, a large number of computational units 7 may similarly be connected to the managing server 1.

The system 100 facilitates a user who uses the client application 10 to send digital content that appears on the display of the hosting unit 7 to a designated mobile device 5. The client application 10 is preferably a software module that can be downloaded from a designated server, via the computer network 6. After the user installs the client application on the hosting computing unit 7, he or she can start sending cellular messages using the system 100. Preferably, during the installation process the user is asked to enter an address of a mobile device. The entered address is used as a default target address to which a cellular message that comprises the designated digital content will be sent if no other address is entered at the time.

Preferably, the client application interacts with the managing server 1 using a web service 106, such as an application programming interface (API) that may be accessed over the computer network 6 and executed on the managing server 1. Preferably, the web service 106 uses a SOAP-formatted XML envelope and a web service description language (WSDL) interface.

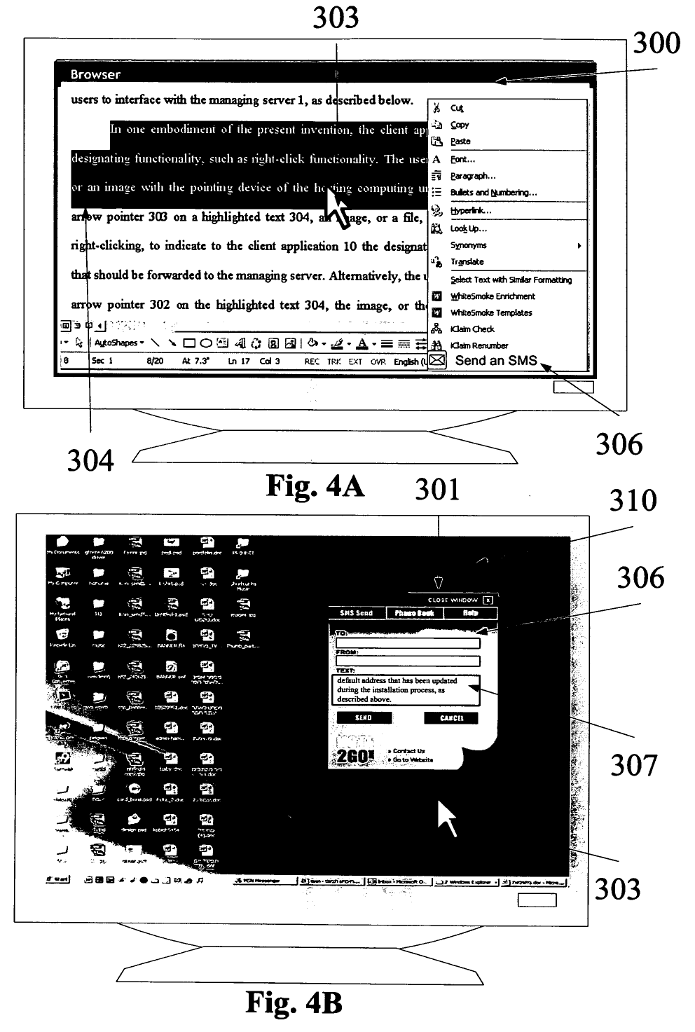

Reference is now made to FIGS. 4A and 4B, which are respectively an exemplary illustration of a screen display 300 and the screen display 310 with a graphical user interface (GUI) for sending digital content 301, according to an embodiment of the present invention. The GUI for sending digital content 301 allows users to interface with the managing server 1, as described below.

In one embodiment of the present invention, the client application provides designating functionality, such as right-click functionality. The user designates a text or an image, preferably with the pointing device of the hosting computing unit. Initially the user places an arrow pointer 303 on a highlighted text 304, an image, or a file having a file name, a shortcut, a link thereto, or an assigned icon that appears on the display. Then, in order to complete the designation, the user right-click to indicate to the client application the designated digital content that should be forwarded to the managing server. Alternatively, the user may place the arrow pointer 303 on the highlighted text 304, the image, or the link, and wait a specified amount of time, to indicate to the client application 10 the designated digital content that should be forwarded to the managing server. Further alternatively, the user may designate the highlighted text 304, the image, or the file by using a key sequence, such as ALT-@, applied when the cursor is anywhere within the desired digital content.

It should be noted that the designated textual and graphical information may be presented by a large variety of applications such as productivity tools, portable document format (PDF) readers and writers, internet browsers, etc. For example, the designated textual and graphical information may be presented by Microsoft™ Office productivity tools such as Microsoft Word®, Microsoft Excel®, Powerpoint®, Outlook®, Microsoft-Access®, Microsoft-Publisher®, Microsoft-notepad®, Microsoft FrontPage®, Microsoft Team Manager®, Microsoft Projects, Microsoft Schedule+®, Microsoft Internet Explorer®, Small Business Financial Manager®, etc.

Preferably, client application automatically transmits the designated digital content over the computer network to the managing server that processes the digital content and transmits data relating thereto to a predefined target address of a certain mobile device. More preferably, a pop-up menu 305 that comprises an assigned tag 306, such as “send an SMS”, appears on the display 300.

As described above, the digital content may comprise textual data. Preferably, a text recognition algorithm, for example, as described in U.S. Pat. No. 6,341,306, entitled “Web-based information retrieval responsive to displayed word identified by a text recognition algorithm” that is incorporated herein by reference, an optical character recognition (OCR) algorithm, or a combination thereof are executed by the client application to transform the digital content to a text that maybe identified by the managing server. Such a transformed digital content is transmitted to the managing server for processing, as described hereinabove.

Preferably, after the digital content has been designated, the GUI for sending digital content 301, as shown in FIG. 4B, pops up. The GUI 301 comprises a command line 306 or a combo box that allows the user to enter or choose a target address of a designated mobile device or to use the default address that has been updated during the installation process, as described above. The target address is associated with the digital content and forwarded to the managing server. Preferably, the GUI 301 allows the user to enter or choose a number of target addresses to a number of designated mobile devices. The target addresses are associated with the digital content and forwarded to the managing server that sends a separate cellular message that comprises the digital content to each one of the target addresses.

Preferably, the GUI 301 presents the digital content in an assigned box 307. Preferably, the user can change or adjust the digital content that is displayed in the assigned box 307. The GUI 301 preferably allows the user to send the designated digital content in one click.

Such right-click functionality can be generated using a JavaScript module. The JavaScript code decides if the user right-clicked in an appropriate area and captures the digital content which is displayed in the appropriate area.

In one embodiment of the present invention, the user designates a link or any other address of a file or a webpage. In such an invention, the designated link or address is forwarded to the managing server that acquires the linked file or webpage and generates based thereupon a cellular message. Preferably, the managing server comprises an acquisition module that acquires the linked file or webpage and forwards it to the transformation module. The transformation module embeds the file or webpage in the cellular message and forwards it to the cellular network, preferably via an MMS/SMS gateway, as described above.

Reference is now made, once again to FIG. 3. As described above, the designated digital content is forwarded, via the computer network 6, to the managing server 1. Preferably, general information about the designated digital content is extracted from the hosting computing unit 7 and forwarded to managing server 1. Such general information may comprise an identifier of the application that presented the designated digital content, information regarding the related client application subscriber, etc.

As described above, the managing server 1 is designed to transform the received digital content to a cellular message that is designated to the target address.

Preferably, the managing server 1 comprises an extraction module that is designed to extract certain information from the designated digital content, preferably according to the general information. If the general information indicates that the designated digital content is taken from a calendar or an email that is displayed on the screen of the hosting computing unit 7, the extraction module may analyze the digital content and extract a predefined set of expected information therefrom. For example, if the digital content is taken from a calendar, the extraction module can extract related information, such as a date, a time, a location, and attendees of a meeting, and enter the extracted information into respective rubrics in a predefined cellular message that is designated to the provided address.

As described in FIG. 3, the managing server 1 is connected to a billing server 101. The billing server 101 stores a number of billing information records, each record is associated with a related subscriber information record. Billing information records may comprise a list of all the sent cellular messages, in relation to sending the date and time, used bandwidth, etc. Subscriber information records may comprise a name, an address, a credit card number, a cellular number, a client number, an ID, etc. In a preferred embodiment of the invention, the subscriber information records comprise information about usage rights of subscribers. Such usage rights may include sending limitations, bandwidth limitations, destination limitations, etc. Using the billing server 101, a system operator can manage usage rights of different users in relation to different cellular messaging. In use, the billing records are updated according to information about the digital content. Preferably, during the installation of each client application, as described above, a subscriber information record is updated with information that allows the billing of cellular messages that are sent therefrom. Preferably, the managing server 1, the billing server 101, or both are designed for authenticating information about the user, such as his mobile number, with the cellular network 8. Preferably, the authentication is performed using a phone-authentication web service 109.

In one embodiment of the present invention, the sent cellular messages are stored in the billing server or in a designated server. The cellular messages are preferably stored in association to information about the sending user and preferably in association to information about the receiving user. In such an embodiment, data mining algorithms and the like may be used for acquiring characteristics and usage pattern of the users. Such information can later be used for personalized advertising, focused marketing, and behavioral based marketing.

In one embodiment of the present invention, when a user desires to use the system 100, he or she must first set up an account that is recorded on the billing server 101. Accounts can be set up on the Internet by accessing a web page of the service provider of the system 100 using the system disclosed herein, or by contacting the customer service representatives of such providers that update the billing server 1 accordingly. When the user sets up an account, he or she provides the telephone number of his or her cellular telephone that will be used as the sending address of the cellular messages and preferably as a default target address for forwarding the cellular messages.

Preferably, the managing server 1, or an associated device, performs a security check 105 before it transforms the received content data to a cellular message. The managing server 1 verifies that the digital content is received from a user that is subscribed in the billing server 101 and preferably if he or she is allowed to send the data content to the designated mobile device. Preferably, the billing server 101 comprises an identification module 107, which is designed for verifying that only authenticated clients, such as the managing server 1 or a system operator, can access the records thereof.

In one embodiment of the present invention, the system 100 functions as a billing system for debiting users for different services and supplies. In such an embodiment, the client application provides users with the ability to purchase services and supplies on their user account, which is preferably stored in the billing server 101. For example, a user can establish audio and video conversations, access websites and online content, download media and software, etc. and bill his account for sending cellular messages on a value that is equal to the value of his one or more purchases. In such an embodiment, the client application is used as a circulation medium. In such an embodiment, the system 10 is used for billing the mobile device owner for purchases. The client application 10 is preferably capable of designating an identifier of a purchase, such as a like or a text, appearing in the display of the hosting computing unit 7. The managing server 1 or another network accessible server is used for identifying the price of the purchase, preferably by accessing a related website or database. The managing server 1 is adapted for forwarding one or more cellular messages to a cellular network that hosts the mobile device, thereby billing the account of the mobile device owner for the purchase.

As described in FIG. 2, the managing server 1 comprises a transformation module and a cellular network interface. The transformation module, which is preferably an SMS/MMS gateway, embeds the received data content in a cellular message that is defined according to a protocol for exchanging cellular messages between cellular peer entities. For example, the cellular message may be defined according to a computer interface to message distribution (CIMD) protocol, short message peer-to-peer protocol (SMPP), external machine interface/universal computer protocol (EMI/UCP), or open interface specification (OIS). The cellular messages, which are generated by the transformation module, are forwarded to the cellular network interface. The cellular network interface connects the managing server 1 to an SMSC of a certain cellular network 8, to a MMSC of a certain cellular network 8, or both. The connection is preferably established via an SMS dealer 102. It should be noted that the managing server might establish a connection with more than one cellular network, preferably using an SMS/MMS web service. Although only one cellular network 8 is depicted in FIG. 3, a large number of cellular networks 8 may similarly be connected to the managing server. If the cellular network 8 is a global system for mobile communications (GSM)-based network, the managing server forwards the cellular message to the SMSC or to the MMSC that forwards the cellular message to a related mobile services switching center (MSC).

Preferably, after the cellular message has been sent to the designated address, the cellular network interface receives a sending indication from the SMSC or to the MMSC. Preferably, after the sending indication is received from the SMSC, the managing server updates the respective subscriber information record in the billing server 101.

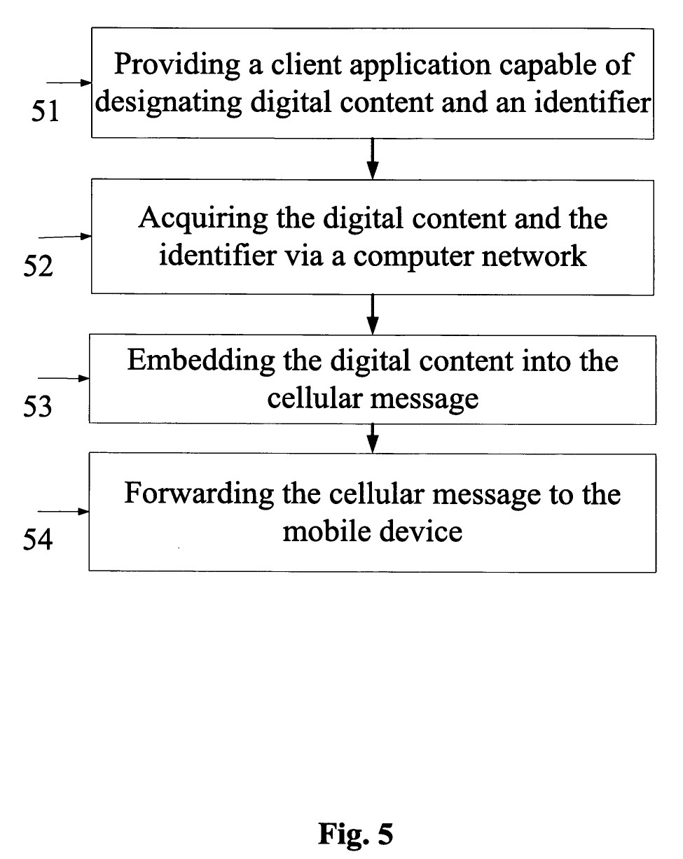

Reference in now made to FIG. 5, which is a flowchart of an exemplary method for providing a mobile device with digital content that appears on a display of a computing unit, according to a preferred embodiment of the present invention.

During the first step, as shown at 51, a client application capable of designating a digital content appears in a display of a hosting computing unit having a connection to a computer network is provided. Such a client application is preferably a JavaScript module that provides a right-click-functionality, as described above. The client application enables a user to designate textual or graphical information that appears in the display and to forward it, via the computer network, to a designated managing server, as described above. The client application enables the user to designate a target address of a mobile device, such as a mobile telephone number or a subscriber ID. Preferably, the target address is sent together with the digital content. Then, as shown at 52, the digital content and the target address are received via the computer network, preferably at the managing server. Now, as shown at 53, the received digital content is embedded into a cellular message that is designated according to target address. As described above, such a cellular message is defined according to a protocol for exchanging cellular messages between cellular peer entities, such as CIMD protocol, SMPP, EMI/UCP, or OIS.

During the following step, as shown at 54, the cellular message is forwarded from the managing server to a remotely located mobile device, according to the target address, via a cellular network. Preferably, the managing server uses an SMS/MMS gateway to make contact with an SMSC or a MMSC that is connected to the cellular network that hosts the related mobile device. The cellular network forwards the cellular message to the related mobile device. The process of sending a cellular network via a cellular network is generally well known and therefore is not described herein in further detail.

It is expected that during the life of this patent many relevant devices and systems will be developed and the scope of the terms herein, particularly of the terms SMSs, MMSs, cellular messages, cellular networks, databases, servers, and records are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for sending digital content to a target mobile device, said method comprising:
a) providing a client application capable of designating an address of the target mobile device, the client application further being capable of designating digital content appearing in a display of a hosting computing unit;
b) acquiring said address and said digital content via a computer network connected to said hosting computing unit;
c) embedding said digital content in a cellular message directed to said address; and
d) forwarding said cellular message to said mobile device via a hosting cellular network.

2. The method of claim 1, wherein said digital content comprises a member of the following group: a textual data, a paragraph, a section of a paragraph, a sentence, a word, a combination of characters, a graphical data, an image, a video track, an audio track, and a file.

3. The method of claim 1, wherein said cellular message comprises a member of the following group: a short message service (SMS) and a multimedia messaging service (MMS).

4. The method of claim 1, wherein said forwarding is performed using a member of the following group: a short message service (SMS) gateway and a multimedia messaging service (MMS) gateway.

5. The method of claim 1, wherein said designating comprises receiving a designation made by a user.

6. The method of claim 1, wherein said designating comprises designating with a pointing device.

7. The method of claim 1, wherein said digital content comprises textual data, said designating comprises causing execution of a text recognition algorithm to identify said textual data.

8. The method of claim 1, wherein said digital content comprises textual data, said designating comprises causing execution of optical character recognition to identify said textual data.

9. The method of claim 1, wherein said forwarding comprises forwarding said cellular message to said cellular network via at least one of the following members: an short message service (SMS) dealer, a multimedia messaging service (MMS) dealer, an SMS center (SMSC), and an MMS center (MMSC).

10. The method of claim 1, wherein said designating is performed by a user, further comprising a step of billing said user for said forwarding.

11. The method of claim 1, wherein said acquiring further comprises acquiring an identifier to said digital content from said client application, wherein said digital content is acquired according to said identifier.

12. The method of claim 11, wherein said identifier is a member of the following group: a link, a pointer, a physical address, and a logical address.

13. The method of claim 12, wherein said forwarding is performed according to a default address if no other address is acquired during step b).

14. The method of claim 1, further comprises a step between step b) and c) of identifying the type of said digital content and extracting predefined information from said digital content according to said identification.

15. The method of claim 14, wherein said type comprises a member of the following group: an email, a schedule, and a note.

16. The method of claim 14, wherein said predefined information comprises a member of the following group: a date, a time, a location, and attendees of a meeting.

17. The method of claim 1, further comprising a step before step b) of acquiring a sending address, wherein said cellular message is defined according to said sending address during said step c).

18. The method of claim 1, wherein said client application capable of designating a number of addresses of a number of respective target mobile devices, said acquiring comprises acquiring said number of addresses, said embedding comprises said digital content in a number cellular messages, each directed to a respective address of said number of addresses, said forwarding comprises forwarding said number cellular messages to said respective mobile devices.

19. The method of claim 1, further comprising a step of storing said cellular message.

20. The method of claim 19, wherein said stored message is used as marketing information.

21. The method of claim 20, wherein said marketing information is used for a member of the following group: personalized advertising, focused marketing, and behavioral based marketing.

22. A system for sending digital content to a mobile device having a target address, comprising:
a client application capable of designating a target address of the mobile device and digital content appearing in a display of a hosting computing unit; and
a network accessible server, operatively connected to said client application via a computer network, being usable for embedding said designated digital content into a cellular message directed to said target address, said network accessible server is adapted for forwarding said cellular message to a cellular network hosting said mobile device, thereby providing said cellular message to said mobile device.

23. The system of claim 22, wherein said digital content comprises a member of the following group: a textual data, a paragraph, a section of a paragraph, a sentence, a word, a combination of characters, a graphical data, an image, a video track, an audio track, and a file.

24. The system of claim 22, wherein said cellular message comprises a member of the following group: a short message service (SMS) and a multimedia messaging service (MMS).

25. The system of claim 22, wherein said designating comprises receiving a designation made by a user of said hosting computing unit.

26. The system of claim 22, wherein designating comprises designating with a pointing device.

27. The system of claim 22, wherein said digital content comprises textual data, wherein said client application comprises a text-grabbing module for identifying said textual data in said digital content, said textual data being embedded into said designated digital content.

28. The system of claim 27, wherein said identification is performed using a member of the following group: a text recognition algorithm and an optical character recognition algorithm.

29. The system of claim 25, further comprising a billing server, operatively connected to said network accessible server, said network accessible server being configured for storing billing information about said user.

30. The system of claim 29, wherein said billing server is used for storing said cellular message.

31. The system of claim 30, wherein said cellular message is used for a member of the following group: personalized advertising, focused marketing, and behavioral based marketing.

32. The system of claim 25, wherein said forwarding comprises forwarding said cellular message to said cellular network via at least one of the following members: an short message service (SMS) dealer, a multimedia messaging service (MMS) dealer, an SMS center (SMSC), and an MMS center (MMSC).

33. The system of claim 29, wherein said network accessible server authenticates said user before said forwarding.

34. A network accessible server adapted to forward digital content to a mobile device, comprising:
an input interface for receiving the digital content and the address of the mobile device from a client application, via the computer network, said digital content comprises information appearing in a display of a computing unit hosting said client application;
a transformation unit for transforming said digital content to a cellular message directed to said address; and
a cellular network interface adapted to be connected to a cellular network hosting the mobile device, thereby allowing the transmission of said cellular message to the mobile device.

35. A system for billing to a mobile device owner for a purchase, comprising:
a client application capable of designating an identifier of the purchase appearing in a display of a hosting computing unit; and
a network accessible server, operatively connected to said client application via a computer network, being usable for identifying the price of said purchase, said network accessible server is adapted forwarding at least one cellular message to a cellular network hosting said mobile device, thereby billing the account of the mobile device owner for said purchase.
